(19) United States
(12) Patent Application Publication
(10) Pub. No.: US 2024/0065340 A1
(43) Pub. Date: Feb. 29, 2024

(54) Aerosol Generation Device with Removable Cover and Display

(71) Applicant: JT International SA, Geneva (CH)

(72) Inventor: Akira Yamaguchi, Geneva (CH)

(73) Assignee: JT International SA, Geneva (CH)

(21) Appl. No.: 18/271,753

(22) PCT Filed: Dec. 22, 2021
(86) PCT No.: PCT/EP2021/087333

§ 371 Date: Jul. 11, 2023

(30) Foreign Application Priority Data
Feb. 1, 2021 (EP) 21154601.5

(51) Int. Cl. A24F 40/65; A24F 40/60

(52) U.S. Cl. CPC A24F 40/65; A24F 40/60; A24F 40/20

(57) ABSTRACT

An aerosol generation device includes a cover with a display. In a 1^{st} aspect, an aerosol generation device includes a main body with a main housing, the main body configured for generating an aerosol from an aerosol generation substrate, and a cover that is releasably attached or connected to the main housing to cover a portion of the outer surface of the main housing. The cover includes as part of its externally visible surface an electronic display that uses non-light-emitting, reflective display technology wherein individual display pixels do not emit light but are visible due to ambient light scattering and reflection.

### FIELD OF INVENTION

The present invention relates to an aerosol generation device, in particular an aerosol generation device comprising a cover with a display.

### TECHNICAL BACKGROUND

Aerosol generation devices commonly found on the marked typically comprise a main unit that is configured for generating an aerosol from a consumable for consumption by a user of the aerosol generation device. While a consumable containing an aerosol generation substrate can be readily exchanged or replaced, the aerosol generation device is often treated as a personal device that is typically not replaced for an extended period time except in cases of damage, malfunction, or breakdown. However, aerosol generation devices commonly available offer very limited possibilities for customizing and personalizing the aerosol generation device via visual and decorative embellishments. While externally visible parts may be provided with embellishments via engravings or similar means, these embellishments are typically permanent and are difficult or impossible to remove or alter. Thus, a user of the aerosol generation device can only personalize the aerosol generation device once. If a user wishes to subsequently provide the customized aerosol generation device with a subsequently new customized appearance, purchase of a new aerosol generation device yet to be customized would be required. This, however, leads to increased cost and material waste. In contrast, embellishments generated with non-permanent customization means that rely on physical or chemical adhesion or adsorption, such as e.g. stickers or film wrappers, can be replaced or altered with limited effort required. However, these embellishments lack durability and degrade quickly over time.

Therefore, there is a need for an aerosol generation device that provides durable and long-lasting visual customization possibilities that can readily be changed and altered with little effort required.

### SUMMARY OF THE INVENTION

Some, or all of the above objectives are achieved by the invention as defined by the features of the independent claims. Preferred embodiments of the invention are defined by the features of the dependent claims.

In a 1^{st} aspect, the invention is an aerosol generation device comprising a main body with a main housing, the main body configured for generating an aerosol from an aerosol generation substrate, and a cover that is releasably attached or connected to the main housing to cover a portion of the outer surface of the main housing. The cover comprises as part of its externally visible surface an electronic display that uses non-light-emitting, reflective display technology wherein individual display pixels do not emit light but are visible due to ambient light scattering and reflection.

The electronic display using a non-light emitting, reflective display technology is advantageous because such display technologies typically require much less energy than displays that actively emit light. In contrast to traditional electronic displays using LCD or OLED technology, non-light-emitting and reflective displays have a much lower energy consumption. Additionally, in contrast to traditional displays, reflective displays have increased readability and visibility of content displayed on the display under brighter ambient conditions without increased energy consumption whereas traditional displays with LCD or OLED technology respectively require a brighter backlighting or brighter individual light-emitting pixels with increased energy consumption to ensure proper readability and visibility. Therefore, due to their low energy consumption, a non-light-emitting and reflective display is well suited for use in aerosol generation device to allow display of user-customizable content on the display for extended periods of time without the risk of rapidly depleting a power source provided with the aerosol generation device. Additionally, providing the display on a removable cover that can be detached from a main body facilitates maintenance, repair and exchange of the display when required.

According to a 2^{nd} aspect, in the preceding aspect, the electronic display comprises or substantially consists of an electronic paper or electronic ink display.

The 2^{nd} aspect is advantageous because an electronic paper or electronic ink display has a very low energy consumption as energy is only consumed when changing content displayed on the display. This allows static content to be displayed almost indefinitely. This makes this display particularly suitable for displaying static content or content with long display refresh cycles for extended periods of time.

According to a 3^{rd} aspect, in the first aspect, the electronic display comprises or substantially consists of a memory-in-pixel (MIP) display.

The 3^{rd} aspect is advantageous because a typical MIP display provides the functionalities of a common LCD display albeit with reduced energy consumption. In an MIP display, a circuit memory is embedded in each pixel to retain pixel information without the need for constant refresh. This affords a display with low energy consumption that is capable of displaying dynamic content with low energy consumption.

According to a 4^{th} aspect, in any of the preceding aspects, the electronic display is configured to display a graphical object, an image, a visual pattern, and/or a plain color.

The 4^{th} aspect allows the display to display user-customizable content to provide the aerosol generation device with a visual appearance according to a user's personal preference.

According to a 5^{th} aspect, in the preceding aspect, the displaying of a graphical object, an image, a visual pattern, and/or a plain color is based on display information provided to the cover and/or the electronic display.

The 5^{th} aspect is advantageous because the visual appearance achieved by content displayed on the display can be readily changed by changing the provided display information.

According to a 6^{th} aspect, in any one of the 4^{th} or 5^{th} aspects, the displaying of a graphical object, an image, a visual pattern, and/or a plain color is based on operational information of the aerosol generation device.

The 6^{th} aspect is advantageous because it allows information indicative of an operational state of the aerosol generation device to be indicated to a user.

According to a 7^{th} aspect, in the preceding aspect, the displaying changes based on changes of the operational information.

The 7^{th} aspect is advantageous because it allows changes to information indicative of an operational state of the aerosol generation device to be indicated to a user.

According to an 8^{th} aspect, in any one of the 5^{th} to 7^{th} aspects, the aerosol generation device is provided with a wired connection between the cover or electronic display and the main body.

The 8^{th} aspect is advantageous because it provides a cost-efficient and reliable means for exchanging electronic information and electric signals between the main body and the cover or display.

According a 9^{th} aspect, in the preceding aspect, the wired connection is configured for supplying power from the main body to the cover and/or electronic display.

The 9^{th} aspect is advantageous because it removes the need for a dedicated power source to be provided for the cover and/or electronic display. This allows the cover to be thinner and lighter.

According to a loth aspect, in any one of the 8^{th} or 9^{th} aspect, the wired connection is configured for communicating the display information and/or the operational information.

The 10^{th} aspect is advantageous because it allows information based on which content on the electronic display is displayed to be directly and reliably communicated to the cover and/or electronic display.

According to an 11^{th} aspect, in any one of the 5^{th} to 10^{th} aspect, the cover and/or electronic display are provided with a wireless interface for receiving the display information and/or the operational information from a remote device and/or the main body.

The 11^{th} aspect is advantageous because information based on which content is displayed on the display can be conveniently communicated to the cover and/or electronic display by a user without the need for the cover and/or electronic display to be wiredly connected to the remote device. In addition, such information can also be communicated when the cover is physically detached from the main body.

According to a 12^{th} aspect, in the preceding aspect, the remote device is or comprises a mobile phone, a personal computer, or a server.

The 12^{th} aspect is advantageous because information based on which content is displayed on the display can be readily accessed, stored, and communicated to the cover and/or electronic display.

According to a 13^{th} aspect, in the 12^{th} aspect, the main body is provided with a wireless interface for communicating the display information and/or the operational information to the cover or the electronic display.

The 13^{th} aspect is advantageous because it allows communicating information based on which content is displayed on the display to be free of wear and tear associated with wired connections. Additionally, such information can be communicated even in a state in which the cover is physically detached from the main body.

According to a 14^{th} aspect, in any one of the 11^{th} to 13^{th} aspects, the wireless interface is a Bluetooth Low Energy (BLE) interface.

The 14^{th} aspect is advantageous because BLE is widely adopted, well documented and standardized wireless communication technology that ensures compatibility with a wide ranges of electronic devices.

According to a 15^{th} aspect, in any one of the preceding aspects, the electronic display makes up 50% or more of the externally visible surface of the cover.

This enhances the visual effect of user-customizable content displayed on the electronic display to provide the aerosol generation device with a desired visual appearance.

According to a 16^{th} aspect according to the preceding aspects, the electronic display is or comprises a touch-sensitive display for receiving touch inputs for operating the aerosol generation device.

The 16^{th} aspect is advantageous because it further allows a user to operate the aerosol generation device using the electronic display, thus reducing the amount of alternative input means such as buttons or switches in order to provide the aerosol generation device with a uniform visual appearance.

According to an 17^{th} aspect, in any one of the preceding aspects, the cover is releasably attached to the main housing via one or more magnetic coupling elements provided with the cover interacting with one or more respective magnetic counter-coupling elements provided with the main housing.

The 17^{th} aspect is advantageous because it provides a means of attaching and detaching the cover from the main body that is reliable, convenient, and free of mechanical wear and tear.

According to a 18^{th} aspect, in any one of the preceding aspects, the main body is provided at the surface of the main housing with one or more interfacial elements.

According to a 19^{th} aspect, in the preceding aspect, the one or more interfacial elements comprise one or more of an operation input element, a light emitting indicator or a charging interface.

According to a 20^{th} aspect, in the preceding aspect, one or more of the one or more interfacial elements are covered by the cover and thus not visible to the outside of the aerosol generation device.

According to a 21^{st} aspect, in the preceding aspect, one or more of the one or more interfacial elements covered by the cover are exposed and accessible to the outside when the cover is detached from the main housing.

The 18^{th} to 21^{st} aspects are advantageous because they allow a user to interact or provide electronic and/or electrical information and signals to the aerosol generation device. Interfaces such as a charging interface or an operation input element such as button can be hidden and protected by the cover when not in use, and at the same time become readily accessible by simply detaching the cover from the main body.

According to a 22^{nd} aspect, in any one of the preceding aspects, the cover is configured to be slidable or rotatable from a first orientation and/or first position to a second orientation and/or second position and relative to the main housing when releasably attached or connected to the main housing.

According to a 23^{rd} aspect, in the preceding aspect, one or more of the one or more interfacial elements covered by the cover are exposed and accessible to the outside when the cover is at the second orientation and/or second position.

The advantages of the 22^{nd} and 23^{rd} aspects are advantageous as any portion of the main body covered by the cover can be readily accesses by rotating the cover without the need to physically detach the cover.

### BRIEF DESCRIPTION OF THE DRAWINGS

FIGS. 1A and 1B respectively show schematic illustrations of a side-view and a top-view of an aerosol generation device, according to embodiments of the invention;

FIGS. 2A, 2B and 2C respectively show schematic illustrations of a top view of an aerosol generation device, a top view of a main housing of the aerosol generation, and a bottom view a cover of the aerosol generation device, according to embodiments of the invention;

FIG. 3 illustrates a main body and a cover of an aerosol generation device according to embodiments of the invention in communication with a remote device.

### DETAILED DESCRIPTION OF PREFERRED EMBODIMENTS

Preferred embodiments of invention are described hereinafter and in conjunction with the accompanying drawings.

In the following detailed description of the present invention, it should be understood that the terms “one end”, “the other end”, “outer side”, “upper”, “above”, “inner side”, “under”, “below”, “horizontal”, “coaxial”, “central”, “end” “part”, “length”, “outer end” etc., which indicate the orientation or positional relationship, are based on the orientation or positional relationship shown in the drawings. The terms such as “upper”, “above”, “below”, “under” and the like used in the present invention to indicate a relative position in space are used for the purpose of facilitating explanation to describe a unit or feature shown in the drawings relative to the relationship of another unit or feature. The term of the relative position in space may be intended to include different orientations of the device in use or operation other than those shown in the figures. For example, if the device in the figure is turned over, the unit described as being “below” or “under” other units or features will be “above” the other units or features. Therefore, the exemplary term “below” can encompass both the above and below orientations. The device can be oriented in other ways (rotated by 90 degrees or other orientations), and the space-related descriptors used herein are explained accordingly. More specifically, the word “above” means that one unit, layer or element is arranged or configured relatively in an exterior direction of the device towards the (an)other unit(s), layer(s) or element(s); the word “below” means that one unit, layer or element is arranged or configured relatively in an interior direction of the device towards the other units, layers or elements.

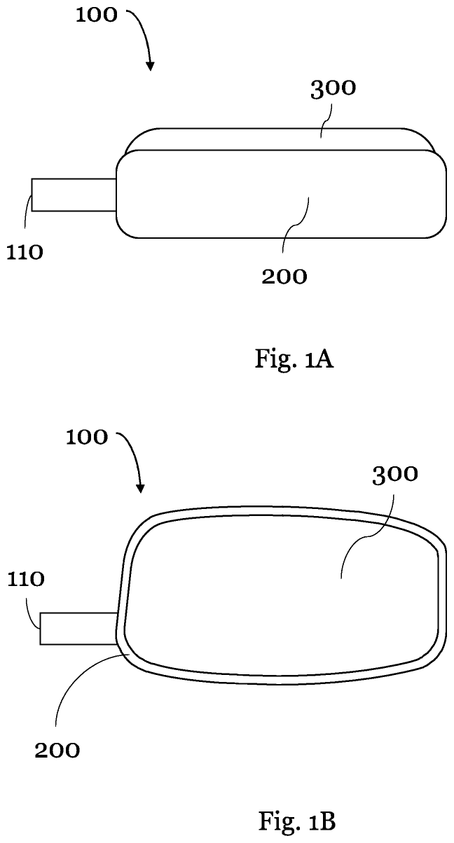

FIGS. 1A and 1B respectively show a side-view and a top-view of an aerosol generation device wo arranged in a horizontal orientation. The aerosol generation device 100 comprises a main body 200 with a main housing and a cover 300 that is releasably attached to the main housing of the main body 200. The main body 200 is configured to accommodate an aerosol generation unit for generating an aerosol for consumption by a user. The aerosol generation device 100 typically comprises an aerosol generation unit for heating and/or receiving a consumable 110 comprising an aerosol generation substrate. The aerosol generation device 100 may be an electronic cigarette and may be configured to generate an aerosol from an e-vapor or t-vapor substrate. For example, the heating unit may comprise a receptacle configured for receiving a tobacco stick or similar consumable 110, and a heating element may be configured for heating the receptable and the tobacco stick received in the receptacle. Alternatively, the receptable may be configured for receiving a cartridge containing an aerosol generation substrate such as a liquid, and the heating unit may comprise a wicking element or the like and a heating element configured for heating the wicking element.

The aerosol generation device 100 may also comprise a power supply that may be a replaceable and/or rechargeable power supply, and may additionally be provided with a USB port or similar interface functioning as a charging port for charging the rechargeable power supply or a data transmission line, and circuitry. The circuitry may comprise a processing unit and/or a memory unit. The cover 300 is arranged above the main body 200 and detachable from the main housing. The cover 300 being detachable means that the cover 300 is detachable from the main housing by a user of the aerosol generation device 100 without requiring any additional tools or aids, but by the user utilizing one or both hands.

The aerosol generation device 100 may have an elongated shape to improve the comfort of a user when holding the aerosol generation device 100. The longitudinal direction of the aerosol generation device 100 is the direction in which the aerosol generation device 100 is elongated. In the embodiment shown in FIGS. 1A and 1B, the longitudinal direction of the aerosol generation device 100 corresponds to a horizontal direction. When viewed from above as shown in FIG. 1B, the cover 300 my preferably have a shape corresponding to the shape of the main housing 200 to contribute to a seamless transition from the main housing 200 to the cover 300. In a preferred embodiment, the cover 300 is attached to the main housing via magnetic means.

The cover 300 may have a central portion that is substantially planar, and one or more peripheral or circumferential portions that are curved or bent to allow the cover 300 to be adjoined to the main housing 200 with a space arranged or enclosed between the main housing 200 and the cover 300 within which one or more operation input elements 230 may be arranged. Alternatively, the cover 300 may have a continuously curved shape with a central portion having a curvature that is smaller than the curvature of one or more peripheral or circumferential portions.

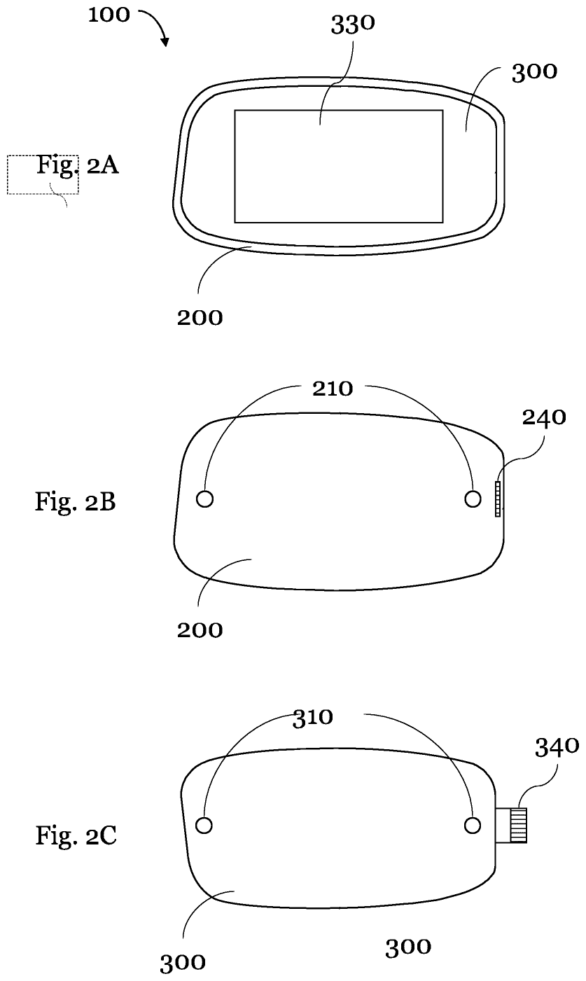

As shown in FIG. 2A, the electronic display 330 is provided with the cover 300 instead of with the main body 200. This is advantageous in several ways. It simplifies maintenance and potential repairs on the display 330 if required. If the display 330 is damaged or requires maintenance, the cover 300 can be detached from the main body 200, and it becomes simple and convenient to access the display 330 and any of its components. Furthermore, it is more convenient to replace a defective display 330 since a user may simply exchange the entire cover 300 comprising the display 330. This is more convenient than replacing a display 330 that is provided with the main housing 200 as it may require special tools and/or the main housing 200 to be opened to remove the defective display 330. This may lead to unintended and accidental damage to the aerosol generation device 100 due to, e.g., wear and tear, or human error. The display 330 forms part of the exterior surface of the cover 300 visible to the outside of the aerosol generation device 100 when attached to the main housing of the main body 200. The exterior surface of the display 330 is preferably arranged to be flush with the surrounding exterior surface of the cover 300 with which the display 330 is provided such that the cover 300 has a smooth exterior surface. Alternatively, depending on the durability of the provided display 330, the exterior surface of the display 330 may be arranged slightly recessed from exterior surface of the surrounding cover 300. This prevents the exterior surface of the display 330 to be subject to potentially damaging influences when the aerosol generation device wo is placed on, e.g., a flat surface when not in use. The display 330 may further be provided with a protective layer forming at least part or all the exterior surface of the display 330.

The cover 300 may have a central portion that is substantially planar, and one or more peripheral or circumferential portions that are curved or bent to allow the cover 300 to be adjoined to the main housing of the main body 200. Alternatively, the cover 300 may have a continuously curved shape with a central portion having a curvature that is smaller than the curvature of one or more peripheral or circumferential portions. While the display 330 may in general have any size and shape suitable for displaying user-customizable content, the electronic display 330 preferably makes up more than 50% of the externally visible surface of the cover 300 to enhance the visual appearance that may be achieved by user-customizable content displayed on the display 330. While the display 330 is preferably a planar display and thus is preferably provided as part of a planar portion of the cover 300, the display 330 may also be a curved display that may be provided as part of a portion of the cover 300 with a curved shape.

The electronic display 330 comprises a non-light-emitting and reflective display technology. This display technology differs from commonly employed displays with transmitting LCD technology or emitting LED technology in that individual pixels are not configured for either transmitting light from a background lighting or emitting light. Rather, individual pixels of the non-light-emitting and reflective display 330 are configured to reflect and scatter ambient light to render individual pixels visible. Compared to a commonly employed transmitting or emitting display, readability and visibility of content displayed on the non-light-emitting and reflective display 330 is increased under bright ambient lighting conditions instead of decreased. Due to the lack of a backlighting or light-emitting pixels, reflective displays are more energy efficient. As a result, the non-light-emitting and reflective display 330 has a very low energy consumption that make them particularly suitable for portable personal devices such as aerosol generation device 100 including electronic cigarettes.

The cover 300 may be releasably attached the main housing of the main body 200 via any suitable means. Such means may comprise mechanical means such as a press-fit connection, a snap-fit connection, interlocking means, or may comprise magnetic means for providing a magnetic connection, or a combination thereof. As shown in FIGS. 2B and 2C, the main body 200 may be provided with a magnetic coupling element 210. Additionally, the cover 300 may be provided with a magnetic counter coupling element 310. The magnetic coupling element 210 and the magnetic counter coupling element 310 may comprise a permanent magnet and a corresponding permanent magnet or ferromagnetic component, or vice versa.

The cover 300 may be provided with a wired interface 340 for electrically and/or electronically connecting to a wired interface 240 provided with the main housing for establishing a wired connection between the main body 200 with the main housing 200 and the cover 300 as well as the display 330 comprised in the cover 300. The wired connection is for exchanging electrical and electronic signals and information between the main body and the cover 300. Exchanging electrical signals may comprise providing power from the main body 200 to the cover 300 and the display 330 if the cover 300 and the display 330 are not provided with a separate, dedicated power source. Additionally, the main body 200 and/or the cover 300 with the display 330 may be provided with a wireless interface. The wireless interface may be for communicating electronic information between the main body 200 and the cover 300 with the display 330. Additionally, or alternatively, the wireless interface may be for communicating electronic information between a remote device and the main body 200 and/or the cover 300 with the display 330.

The electronic display 330 comprises or substantially consists of a non-light-emitting and reflective display 330. The non-light-emitting and reflective display 330 may comprise or substantially consist of an electronic paper or electronic ink display, or a memory-in-pixel (MIP) LCD display. In addition, having the advantages of a reflective display, an electronic paper or ink display or a MIP LCD display is further advantageous due to having very low energy consumption. This is because little to no energy is required to uphold display of a static or still image. In an electronic paper or electronic ink display, charged and dyed particles are contained in thin layer, and the appearance of individual pixels is controlled via a plurality of electrodes that are provided above and below the thin layer containing charged and dyed particles. Changing the polarity across the layer via the electrodes allows dyed particles to become visible, hence creating the appearance of individual pixels. An MIP display utilizes a reflective LCD display that is provided with a reflective base layer instead of a backlighting source. Hence, any individual pixels become visible due to ambient light being reflected by the reflective base layer. In addition, in a MIP display, each individual pixel is provided with a circuit memory, typically SRAM. The circuit memory allows an individual pixel state to be saved instead of requiring the pixel state to be constantly refreshed, which in common LCD or OLED displays typically occurs at a frequency between 30 Hz and 120 Hz. In electronic paper or electronic ink displays as well as MIP LCD displays, since static images do not require constant refresh of individual pixel states, such static images require little to no energy to be displayed over an extended period of time. This makes an electronic paper or ink display as well as an MIP LCD display particularly suitable for use in or as display 330 for displaying user-customizable content in order to provide the exterior of aerosol generation device 100 with a user-customizable visual appearance.

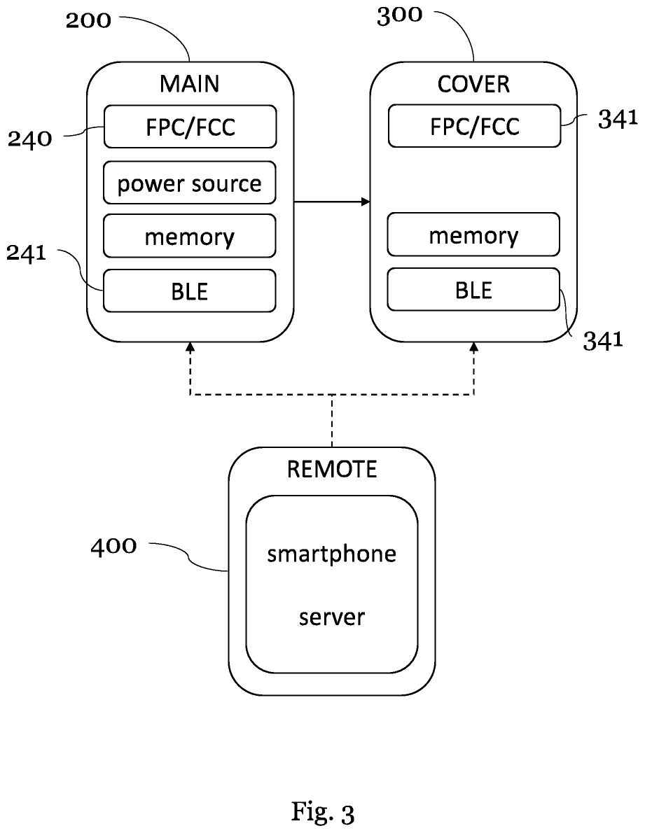

As shown in FIG. 3, the main body 200 and the cover 300 may be configured to communicate and exchange information for displaying user-customizable content on the display 330 using different methods. The display 330 may be configured for displaying a variety of user-customizable content that includes, but is not limited to, one or more of a graphical object, an image, a visual pattern, and/or a plain color. Depending on the type of display utilized, the displayed content may be colored and/or monochromatic, and may be static or dynamic. For displaying user-customizable content, the cover 300 with the display 330 may be provided with a memory for storing user-customizable content to be displayed. Alternatively, user-customizable content may be provided directly to the display 330. User-customizable content may be provided to the cover memory and/or the display 330 from the main body 200 using a wired connection established between wired interfaces 240 and 340 respectively provided with the main body 200 and the cover 300. The wired interfaces 240 and 340 preferably comprise FPC/FCC connectors, but any suitable wired interfaces may be utilized. Alternatively, the main body 200 and the cover 300 may respectively be provided with wireless interfaces 241 and 341 for establishing a wireless connection, and user-customizable content may be provided via the wireless interface. Additionally, or alternatively, user-customizable content may first be provided from a remote device 400 to the main body 200 via wireless interface 241, and subsequently provided to the cover 300 using any of the above detailed methods and means. Alternatively, the user-customizable content may be provided from the remote device 400 directly to the cover 300 and/or display using wireless interface 341. The remote device 400 may comprise a personal electronic device such as a smartphone or personal computer, and a server or cloud storage. In a preferred embodiment, the cover 300 and/or the display 330 is configured for communicating with the main body 200 and/or a remote device 400 via a Bluetooth Low Energy (BLE) wireless interface.

When displaying user-customizable content, the content may be provided to the cover 300 and/or display 330 using any of the above detailed methods and means, and displaying the content may be based on input from a user. For example, a plurality of graphical objects, images, visual patterns and/or colors may be provided to the cover 300 and/or display 330, and a user may provide input to the display 330, either via an input means provided with the aerosol generation device 100 or via a remote device 400, to provide display information based on which one or more of the plurality of graphical objects, images, visual patterns and/or colors are displayed on the display 330. The provided display information may indicate a single graphical object, image, visual pattern and/or color to be displayed, or a plurality of graphical objects, images, visual patterns and/or colors to be cyclically displayed and changed. Additionally, or alternatively, the user-customizable content may be displayed based on operational information of the aerosol generation device 100 provided to the cover 300 and/or the display 330 using any one of the above detailed wired or wireless connections. For example, user-customizable content may be based on information regarding an operational state of the aerosol generation device wo including, but not limited to, a battery charging level, an operation temperature for generating an aerosol, a remaining amount of aerosol generation substrate, total operational time since a last maintenance action by a user, and an amount of user puffs. For example, based on the operational information and/or changes to the operational information, a specific graphical object, image, visual pattern and/or color may be displayed. Additionally, or alternatively, a displayed graphical object, image, visual pattern and/or color may change in color or brightness, and/or change to a different graphical object, image, visual pattern and/or color.

In order to allow a user to provide input to the aerosol generation device 100 for controlling the aerosol generation device 100 and/or controlling display of user-customizable content displayed on display 330, the display 330 may comprise or substantially consist of a touch-sensitive display configured for receiving touch inputs. Additionally, or alternatively, interfacial elements comprising a button, switch, toggle, data interface charging interface, and light-emitting indicator such as an LED light source may be provided such that they are accessible on the main housing of the main body 200. Additionally, interfacial elements may be provided such that they are covered by the cover 300 when the cover 300 is attached to the main housing of the main body 200 and consequently not accessible and not visible to the outside of the aerosol generation device loft Detaching or otherwise moving the cover 300 relative to the main housing of the main body 200 may render interfacial element accessible to a user.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the scope of this disclosure, as defined by the independent and dependent claims.

### LIST OF REFERENCE SIGNS USED

100 aerosol generation device
110 consumable
200 main body with main housing
210 attaching means
240 main body wired interface
241: main body wireless interface
300 cover
310 attaching means
330 display
340 cover wired interface
341 cover wireless interface
400 remote device

1. An aerosol generation device comprising:
a main body with a main housing, the main body configured for generating an aerosol from an aerosol generation substrate;
a cover that is releasably attached or connected to the main housing to cover a portion of an outer surface of the main housing; wherein
the cover comprises as part of its externally visible surface an electronic display that uses non-light emitting, reflective display technology wherein display pixels do not emit light but are visible due to ambient light scattering and reflection.

2. The aerosol generation device according to claim 1, wherein the electronic display comprises or substantially consists of an electronic paper or electronic ink display.

3. The aerosol generation device according to claim 1, wherein the electronic display comprises or substantially consists of a memory-in-pixel (MIP) display.

4. The aerosol generation device according to claim 1, wherein the electronic display is configured to display a graphical object, an image, a visual pattern, and/or a plain color.

5. The aerosol generation device according to claim 4, wherein the displaying of a graphical object, an image, a visual pattern, and/or a plain color is based on display information provided to the cover and/or the electronic display.

6. The aerosol generation device according to claim 4, wherein the display of a graphical object, an image, a visual pattern, and/or a plain color is based on operational information of the aerosol generation device.

7. The aerosol generation device according to claim 6, wherein the display changes based on changes of the operational information.

8. The aerosol generation device according to claim 1, wherein the aerosol generation device is provided with a wired connection between the cover or the electronic display and the main body.

9. The aerosol generation device according to claim 8, wherein the wired connection is configured for supplying power from the main body to the cover and/or the electronic display.

10. The aerosol generation device according to claim 5, wherein the aerosol generation device is provided with a wired connection between the cover or the electronic display and the main body, and wherein the wired connection is configured for communicating the display information.

11. The aerosol generation device according to claim 1, wherein the cover and/or the electronic display are provided with a wireless interface for receiving display information and/or operational information from a remote device and/or the main body.

12. The aerosol generation device according to claim 11, wherein the remote device is or comprises a mobile phone, a personal computer, or a server.

13. The aerosol generation device according to claim 11, wherein the main body is provided with a wireless interface for communicating the display information and/or the operational information to the cover and/or the electronic display.

14. The aerosol generation device according to claim 11, wherein the wireless interface is a Bluetooth Low Energy (BLE) interface.

15. The aerosol generation device according to claim 1, wherein the cover is releasably attached to the main housing via one or more magnetic coupling elements provided with the cover interacting with one or more respective magnetic counter-coupling elements provided with the main housing.
